(19) United States
(12) Patent Application Publication
(10) Pub. No.: US 2022/0338137 A1
(43) Pub. Date: Oct. 20, 2022

(54) COMPARISON DEVICE, COMMUNICATION SYSTEM, COMPARISON METHOD, AND COMPARISON PROGRAM

(71) Applicant: Nippon Telegraph and Telephone Corporation, Tokyo (JP)

(72) Inventors: Takuya SATO, Musashino-shi, Tokyo (JP); Tomohiro OKADA, Musashino-shi, Tokyo (JP); Takayuki NAKAMURA, Musashino-shi, Tokyo (JP); Shunsuke HOMMA, Musashino-shi, Tokyo (JP); Hidetaka NISHIHARA, Musashino-shi, Tokyo (JP)

(21) Appl. No.: 17/635,449

(22) PCT Filed: Aug. 23, 2019
(86) PCT No.: PCT/JP2019/033185

§ 371 Date: Feb. 15, 2022

(51) Int. Cl. H04W 56/00; H04W 28/06; H04W 24/08

(52) U.S. Cl. CPC H04W 56/00; H04W 28/065; H04W 24/08

(57) ABSTRACT

An acquisition unit (15a) acquires packets passing through an active system path and packets passing through a standby system path. An aggregation unit (15b) aggregates information on the packets using the acquired packets. A determination unit (15c) compares the aggregated information on the packets between the active system path and the standby system path to determine whether there is a difference in state information indicating an operational state in an NF. In a case where it is determined that there is the difference, an instruction unit (15d) instructs an NF of the active system path and an NF of the standby system path facing the NF of the active system path to synchronize the state information.

### TECHNICAL FIELD

The present invention relates to a comparison device, a communication system, a comparison method, and a comparison program.

### BACKGROUND ART

At present, studies are underway toward the start of commercial services for 5th generation mobile communication systems (5G), and as a use case for this, a technique utilizing the characteristics of ultra-reliable and low latency communications (URLLC) is expected. The 3rd Generation Partnership Project (3GPP) and the International Telecommunication Union Radiocommunication sector (ITU-R), which are standardization organizations, define “a transmission success rate of 99.999% or more of the amount of packet data of 32 bytes or more” as one of the conditions of URLLC (see NPL 1).

For example, there is a method of improving the reliability of a communication network by making paths designed with redundancy and passing packets through both paths. That is, communication can be continued by discarding one of packets that have flowed in duplicate on the reception side in a normal state and switching to the other during the occurrence of a failure or the like. Regarding communication in URLLC requiring high reliability even in 5G, paths in a 5G core are duplexed, the same packets flow through both paths, and packets in one path are discarded on the reception side (see NPL 2). Meanwhile, a configuration in a data network (DN) is not clearly defined in the current state.

### CITATION LIST

### Non Patent Literature

NPL 1: 3GPP TR 38.913, [online], June, 2018, [retrieved on Jul. 23, 2019], the Internet <http://www.3gpp.org/ftp//Specs/archive/38_series/38.913/38913-f00.zip>
NPL 2: 3GPP TS 23.501, [online], June, 2019, [retrieved on Jul. 23, 2019], the Internet <http://www.3gpp.org/ftp//Specs/archive/23_series/23.501/23501-g10.zip>

### SUMMARY OF THE INVENTION

### Technical Problem

However, in the related art, an influence on communication such as a slight packet loss that cannot be avoided during operation may become unacceptable in URLLC. For example, in a case where a packet loss occurs in a path of a standby system, retransmission processing or the like in a user equipment (UE) is not performed, and thus a difference occurs between packets passing through a network function (NF) of an active system and packets passing through an NF of a standby system. As a result, the occurrence of a discrepancy in an operational state (state information) between NFs will influence communication in NFs such as fire wall (FW) or deep packet inspection (DPI) in which stateful processing of reflecting the current state is performed when the active system is switched to the standby system. On the other hand, when the operational state is synchronized between NFs at all times, the amount of information or the frequency of occurrence of updating increases, and a load on a network increases.

The present invention was contrived in view of the above point, and an object thereof is to reduce the influence of a packet loss on communication in duplexed network devices.

### Means for Solving the Problem

In order to solve the above problems and achieve the object, according to the present invention, there is provided a comparison device including an acquisition unit configured to acquire a packet passing through an active system path and a packet passing through a standby system path, an aggregation unit configured to aggregate pieces of information on the packet using the packet acquired, a determination unit configured to compare the pieces of information on the packet aggregated between the active system path and the standby system path to determine whether there is a difference in state information indicating an operational state in a network function (NF), and an instruction unit configured to instruct an NF of the active system path and an NF of the standby system path facing the NF of the active system path to synchronize the state information in a case where it is determined that there is the difference.

### Effects of the Invention

According to the present invention, it is possible to reduce the influence of a packet loss on communication in duplexed network devices.

### BRIEF DESCRIPTION OF DRAWINGS

FIG. 1 is a schematic diagram illustrating a configuration of a communication system including a comparison device of the present embodiment.

FIG. 2 is a schematic diagram illustrating a configuration of a communication system including the comparison device of the present embodiment.

FIG. 3 is a schematic diagram illustrating a configuration of a communication system including the comparison device of the present embodiment.

FIG. 4 is a schematic diagram illustrating an outline configuration of the comparison device of the present embodiment.

FIG. 5 is a schematic diagram illustrating an outline configuration of an NF which is a target for comparison processing.

FIG. 6 is a sequence diagram illustrating a comparison processing procedure.

FIG. 7 is a diagram illustrating an example of a computer that executes a comparison program.

### DESCRIPTION OF EMBODIMENTS

Hereinafter, an embodiment of the present invention will be described in detail with reference to the accompanying drawings. Meanwhile, the present invention is not limited by this embodiment. In addition, in the description of the drawings, the same components are denoted by the same reference signs.

Configuration of Communication System

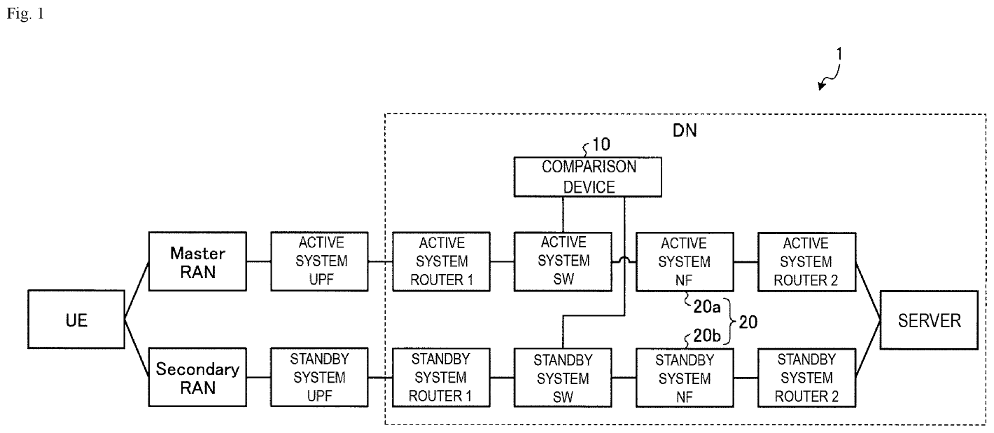

FIGS. 1 to 3 are schematic diagrams illustrating a configuration of a communication system including a comparison device of the present embodiment. As illustrated in FIG. 1, in a communication system 1 to be processed by a comparison device 10, a UE which is connected to a radio access network (RAN) communicates with a server in a DN through a user plane function (UPF). In the DN, an NF 20 that performs stateful processing on passing packets and a server are connected to each other through a router.

In the communication system 1, a path from the UE to the server is duplexed by an active system path and a standby system path. The active system path is constituted by a master RAN, an active system UPF, an active system router 1, an active system NF 20a, and an active system router 2. In addition, the standby system path is constituted by a secondary RAN, a standby system UPF, a standby system router 1, a standby system NF 20b, and a standby system router 2.

The comparison device 10 makes a comparison by performing comparison processing to be described below and acquiring information on packets passing through each of the active system path and the standby system path. Then, in a case where a difference is found between the two, the comparison device 10 determines that a discrepancy has occurred in the operational states (state information) of the active system NF 20a and the standby system NF 20b up to the present. In that case, the active system NF 20a and the standby system NF 20b synchronize the state information with each other.

Meanwhile, as illustrated in FIG. 1, the comparison device 10 is connected to an active system SW and a standby system SW which are disposed in the middle of the active system path and the standby system path, and acquires packets duplicated by port mirroring from each SW in the comparison processing to be described below.

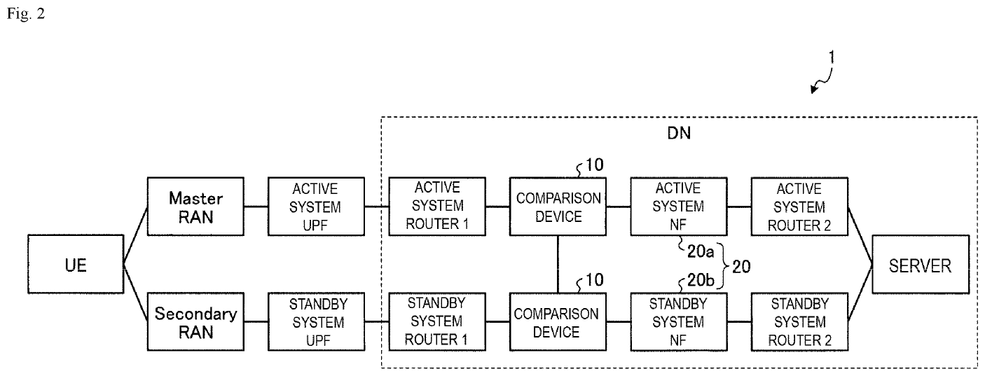

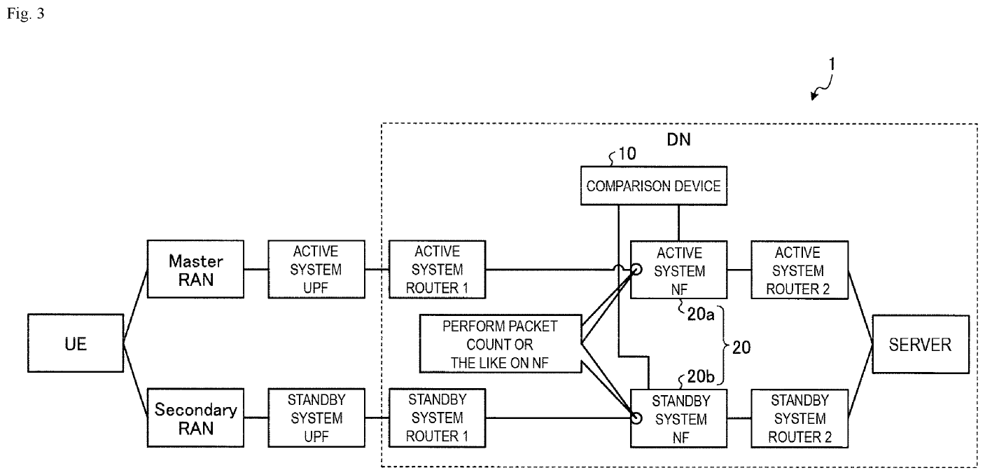

Alternatively, as illustrated in FIG. 2, the comparison device 10 may be disposed in the middle of the active system path and the standby system path. Alternatively, as illustrated in FIG. 3, the comparison device 10 may be connected to the active system NF 20a and the standby system NF 20b. In that case, each of the active system NF 20a and the standby system NF 20b aggregates the information on passing packets. The comparison device 10 acquires information on packets from the active system NF 20a and the standby system NF 20b in the comparison processing to be described below.

Configuration of Comparison Device

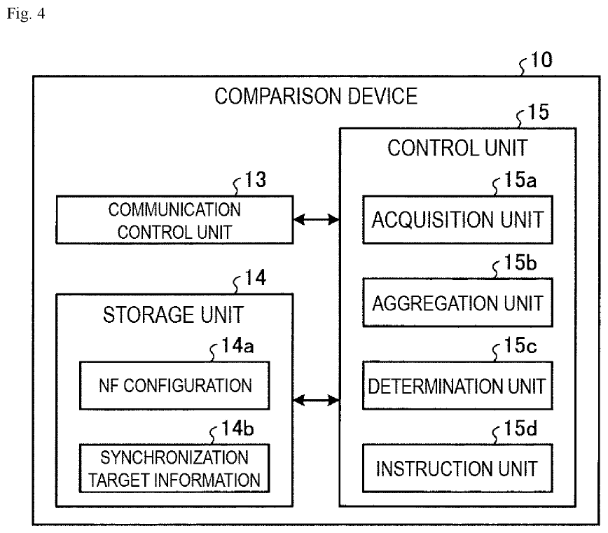

FIG. 4 is a schematic diagram illustrating an outline configuration of the comparison device of the present embodiment. As illustrated in FIG. 4, the comparison device 10 of the present embodiment is implemented by a general-purpose computer or the like, and includes a communication control unit 13, a storage unit 14, and a control unit 15.

The communication control unit 13 is implemented by a network interface card (NIC) or the like, and controls communication between the control unit 15 and an external device such as another network device through an electric communication line such as a local area network (LAN) or the Internet. For example, the communication control unit 13 controls communication between the SW or the NF 20 and the control unit 15 which are disposed in the path.

The storage unit 14 is implemented by a semiconductor memory element such as a random access memory (RAM) or a flash memory, or a storage device such as a hard disk or an optical disc. In the storage unit 14, a processing program for bringing the comparison device 10 into operation, data used during the execution of the processing program, and the like are stored in advance, or are temporarily stored every time processing is performed. Meanwhile, the storage unit 14 may be configured to communicate with the control unit 15 through the communication control unit 13.

In the present embodiment, the storage unit 14 stores an NF configuration 14a and synchronization target information 14b. The NF configuration 14a is information for managing a combination of the NFs 20 facing each other between the active system path and the standby system path. The synchronization target information 14b is information indicating state information to be synchronized in the comparison processing to be described below among the state information indicating the operational states in the NF 20. This information is acquired from a management device or the like that manages a network configuration or the like before the comparison processing to be described below and is stored in the storage unit 14.

The control unit 15 is implemented using a central processing unit (CPU), a network processor (NP), a field programmable gate array (FPGA), or the like, and executes the processing program stored in a memory. Thereby, the control unit 15 functions as an acquisition unit 15a, an aggregation unit 15b, a determination unit 15c, and an instruction unit 15d.

Meanwhile, each or some of these functional units may be mounted in different hardware. For example, the aggregation unit 15b may be mounted in the NF 20 to be described below. In addition, the control unit 15 may include other functional units. In addition, the control unit 15 may be mounted in another network device within the communication system 1.

The acquisition unit 15a acquires packets passing through the active system path and packets passing through the standby system path. For example, as illustrated in FIG. 1, the acquisition unit 15a acquires packets duplicated by port mirroring from the SW inserted in the active system path and the standby system path through the communication control unit 13.

Alternatively, as illustrated in FIG. 2, the acquisition unit 15a acquires packets from the routers adjacent to each other within the active system path and the standby system path through the communication control unit 13. Meanwhile, the acquisition unit 15a may cause the storage unit 14 to store the acquired packets. Alternatively, the acquisition unit 15a may transfer the acquired packets to the aggregation unit 15b without causing the storage unit 14 to store them.

The aggregation unit 15b aggregates information on the packets using the acquired packets. For example, the aggregation unit 15b counts the number of packets having passed through each of the active system path and the standby system path in a predetermined period. Alternatively, the aggregation unit 15b collects predetermined information such as headers of the packets having passed through each of the active system path and the standby system path. Alternatively, the aggregation unit 15b samples the packets having passed through each of the active system path and the standby system path at a predetermined frequency of occurrence. Meanwhile, the aggregation unit 15b may transfer all the data of the passed packets to the determination unit 15c.

The determination unit 15c compares the aggregated information on the packets between the active system path and the standby system path to determine whether there is a difference in the state information indicating the operational state in the NF 20.

For example, the determination unit 15c compares the number of packets, data of the sampled packets, or data of all the packets as the aggregated information on the packets. Meanwhile, the information on the packets to be compared by the determination unit 15c is selected in advance in accordance with the reliability and processing load required for the communication system. In addition, the determination unit 15c refers to the NF configuration 14a to identify a combination of the NF 20a of the active system path and the NF 20b of the standby system path which are targets for comparison.

As a result of the comparison, the determination unit 15c determines whether a discrepancy has occurred, that is, there is a difference, in the state information between the NF 20a of the active system path and the NF 20b of the standby system path.

For example, in a case where there is no difference in the information on the packets, the determination unit 15c determines that a discrepancy has not occurred and there is no difference in the state information between the NF 20a of the active system path and the NF 20b of the standby system path. On the other hand, in a case where there is a difference in the information on the packets, the determination unit 15c determines that a discrepancy has occurred and there is a difference in the state information between the NF 20a of the active system path and the NF 20b of the standby system path.

Meanwhile, the state information which is a target for synchronization is determined in advance in accordance with the configuration of the NF, the type or content of the packet, or the like, and is stored in the storage unit 14 as the synchronization target information 14b. In that case, the determination unit 15c refers to the storage unit 14 to determine whether there is a difference in the state information which is a target for synchronization.

In a case where it is determined that there is a difference, the instruction unit 15d instructs the NF 20a of the active system path and the NF 20b of the standby system path facing the NF 20a of the active system path to synchronize the state information. Specifically, the instruction unit 15d refers to the NF configuration 14a and the synchronization target information 14b, and instructs the NF 20a of the active system path and the NF 20b of the standby system path of the state information which is a target for synchronization and its synchronization.

In addition, the instruction unit 15d acquires and manages the result of the synchronization processing from the NF 20a of the active system path and the NF 20b of the standby system path.

Configuration of NF

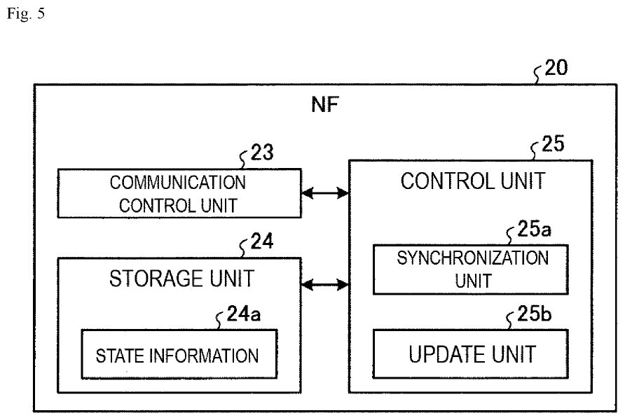

FIG. 5 is a schematic diagram illustrating an outline configuration of the NF 20 which is a target for comparison processing. As illustrated in FIG. 5, the NF 20 is implemented by a general-purpose computer or the like, and includes a communication control unit 23, a storage unit 24, and a control unit 25. For example, the NF 20 performs stateful processing such as FW or DPI.

The communication control unit 23 is implemented by a network interface card (NIC) or the like, and controls communication between the control unit 25 and an external device such as another network device through an electric communication line such as a local area network (LAN) or the Internet. For example, the communication control unit 23 controls communication between the comparison device 10 and the facing NF 20 and the control unit 25.

The storage unit 24 is implemented by a semiconductor memory element such as a random access memory (RAM) or a flash memory, or a storage device such as a hard disk or an optical disc. In the storage unit 24, a processing program for bringing the NF 20 into operation, data used during the execution of the processing program, and the like are stored in advance, or are temporarily stored every time processing is performed. Meanwhile, the storage unit 24 may be configured to communicate with the control unit 25 through the communication control unit 23.

In the present embodiment, the storage unit 24 stores state information 24a and the like. The state information 24a is a result of stateful processing in the NF 20 and is information indicating an operational state up to the present.

The control unit 25 is implemented using a central processing unit (CPU), a network processor (NP), a field programmable gate array (FPGA), or the like, and executes the processing program stored in a memory. Thereby, the control unit 25 functions as a synchronization unit 25a and an update unit 25b.

In a case where synchronization is instructed from the comparison device 10, the synchronization unit 25a performs synchronization of the instructed state information which is a target for synchronization with the facing NF 20. For example, the synchronization unit 25a reads out the state information 24a which is a target for synchronization from the storage unit 24, compares the difference with the facing NF 20, and performs the synchronization processing. In addition, the synchronization unit 25a executes state management required for the synchronization processing.

The update unit 25b updates the synchronized state information 24a. That is, the update unit 25b updates the state information 24a of the storage unit 24 using the state information on which the synchronization unit 25a has performed the synchronization processing.

Meanwhile, as illustrated in FIG. 3, the NF 20 may have the aggregation unit 15b of the comparison device 10 described above instead of the comparison device 10. In that case, in the comparison device 10, the determination unit 15c acquires the aggregated information on the packets from the NF 20.

Comparison Processing

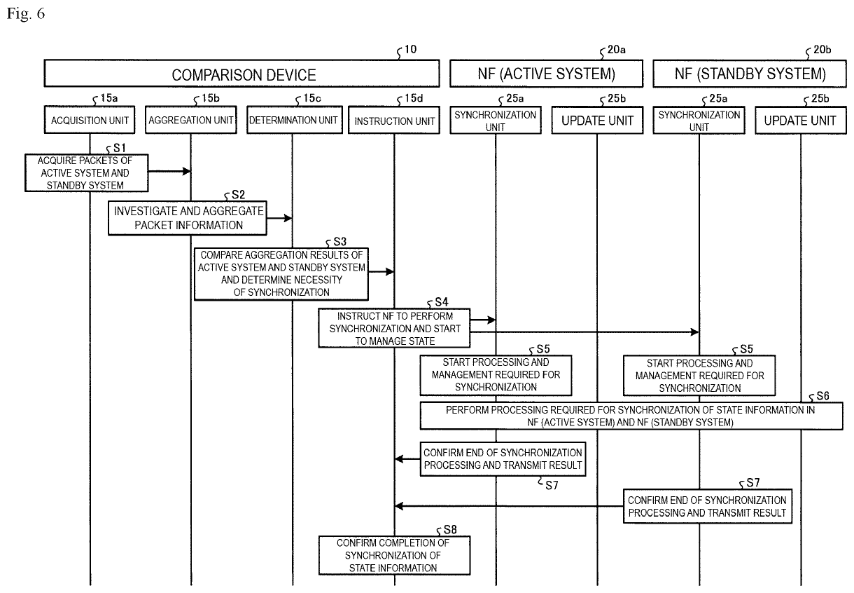

Next, the comparison processing performed by the comparison device 10 and the NF 20 according to the present embodiment will be described with reference to FIG. 6. FIG. 6 is a sequence diagram illustrating a comparison processing procedure. The sequence of FIG. 6 is started, for example, at a timing at which a user performs an operation input for a start instruction.

First, in the comparison device 10, the acquisition unit 15a acquires packets passing through the active system path and packets passing through the standby system path (step S1). Meanwhile, the acquisition unit 15a may acquire information aggregated in another network device.

Next, the aggregation unit 15b investigates and aggregate information on the packets using the acquired packets (step S2). In addition, the determination unit 15c compares the aggregated information on the packets between the active system path and the standby system path, and determines whether there is a difference in the state information 24a between the NF 20a and the NF 20b, that is, the necessity of synchronization of the state information 24a (step S3).

In a case where it is determined that there is a difference and synchronization is necessary, the instruction unit 15d instructs the NF 20a of the active system path and the NF 20b of the standby system path facing the NF 20a to synchronize the state information, and starts to manage the state of the synchronization processing (step S4).

In the active system NF 20a and the standby system NF 20b which are instructed to synchronize the state information from the comparison device 10, each of the synchronization units 25a starts processing and management required for the synchronization of the instructed state information which is a target for synchronization (step S5).

The synchronization units 25a of the active system NF 20a and the standby system NF 20b mutually perform the synchronization processing required for the synchronization of the state information 24a. For example, the synchronization units 25a read out the respective state information 24a. In addition, the synchronization units 25a mutually transmit and receive the state information between the NFs to compare the difference, and perform state management required for the synchronization processing. In addition, the update units 25b update the respective state information 24a using the synchronized state information (step S6).

In addition, in a case where each of the synchronization units 25a confirms the end of the synchronization processing, each of the synchronization units 25a transmits the result to the comparison device 10 (step S7).

In the comparison device 10, the instruction unit 15d confirms the completion of the synchronization processing from the NF 20a of the active system path and the NF 20b of the standby system path (step S8), and manages the result of the synchronization process. This concludes a series of comparison processing operations.

Hereinbefore, as described above, in the comparison device 10 of the present embodiment, the acquisition unit 15a acquires packets passing through the active system path and packets passing through the standby system path. The aggregation unit 15b aggregates information on the packets using the acquired packets. The determination unit 15c compares the aggregated information on the packets between the active system path and the standby system path, and determines whether there is a difference in the state information indicating the operational state in the NF 20. In a case where it is determined that there is a difference, the instruction unit 15d instructs the NF 20a of the active system path and the NF 20b of the standby system path facing the NF 20a of the active system path to synchronize the state information.

Thereby, the comparison device 10 can efficiently synchronize the operational state between the NFs while suppressing a load on a network. Accordingly, even when a slight packet loss that cannot be avoided during operation occurs, an influence on communication in the case of switching to the standby system can be reduced to a range allowed by URLLC. In this manner, it is possible to reduce the influence of a packet loss on communication in duplexed network devices.

In addition, the storage unit 14 may store information for managing the state information which is a target for synchronization, and the determination unit 15c may refer to the storage unit 14 to determine whether there is a difference in the state information which is a target for synchronization. Thereby, the comparison device 10 can more efficiently determine the occurrence of discrepancy of the state information.

In addition, as illustrated in FIG. 3, the NF 20 may have the aggregation unit 15b of the comparison device 10 instead of the comparison device 10. In that case, the determination unit 15c acquires the aggregated information on the packets from the NF 20. This makes it possible to further reduce the processing load of the comparison device 10.

Program

It is also possible to create a program in which processing executed by the comparison device 10 and the NF 20 according to the above embodiment is described in a computer-executable language. As an embodiment, the comparison device 10 and the NF 20 can be implemented by installing a comparison program for executing the above comparison processing as package software or online software on a desired computer. For example, an information processing device can be made to function as the comparison device 10 by causing the information processing device to execute the above comparison program. The information processing device referred to here includes a desktop-type or note-type personal computer. In addition, the category of the information processing device includes a mobile communication terminal such as a smartphone, a cellular phone, and a personal handyphone system (PHS), a slate terminal such as a personal digital assistant (PDA), and the like. In addition, the function of the comparison device 10 may be implemented in a cloud server.

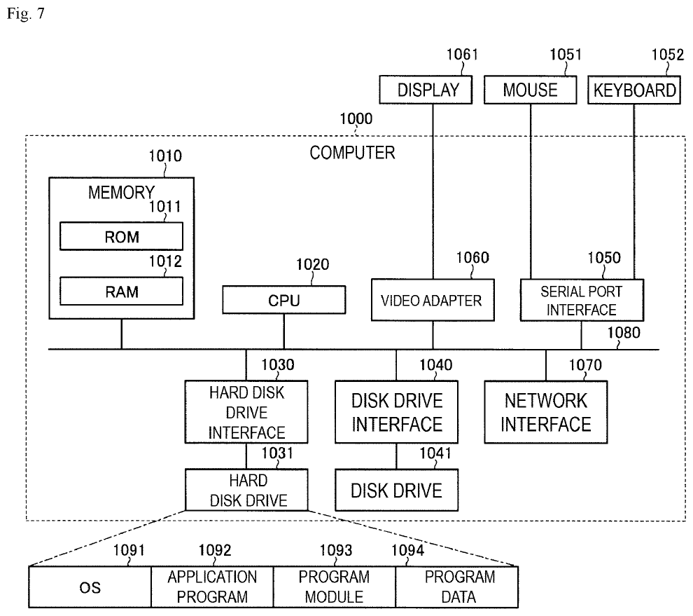

FIG. 7 is a diagram illustrating an example of a computer that executes a comparison program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other through a bus 1080.

The memory 1010 includes a read only memory (ROM) 1011 and a random access memory (RAM) 1012. The ROM 1011 stores a boot program such as, for example, a basic input output system (BIOS). The hard disk drive interface 1030 is connected to a hard disk drive 1031. The disk drive interface 1040 is connected to a disk drive 1041. A removable storage medium such as, for example, a magnetic disc or an optical disc is inserted into the disk drive 1041. For example, a mouse 1051 and a keyboard 1052 are connected to the serial port interface 1050. For example, a display 1061 is connected to the video adapter 1060.

Here, the hard disk drive 1031 stores, for example, an operating system (OS) 1091, an application program 1092, a program module 1093, and program data 1094. The information described in the embodiment is stored in, for example, the hard disk drive 1031 or the memory 1010.

In addition, the comparison program is stored in the hard disk drive 1031 as, for example, the program module 1093 in which commands executed by the computer 1000 are described. Specifically, the program module 1093 in which each processing executed by the comparison device 10 described in the above embodiment is described is stored in the hard disk drive 1031.

In addition, data used in information processing based on the comparison program is stored in, for example, the hard disk drive 1031 as the program data 1094. The CPU 1020 reads out the program module 1093 and the program data 1094 stored in the hard disk drive 1031 into the RAM 1012 as necessary, and executes each procedure described above.

Meanwhile, the program module 1093 and the program data 1094 related to the comparison program are not limited to a case where they are stored in the hard disk drive 1031, and may be stored in, for example, a removable storage medium and be read out by the CPU 1020 through the disk drive 1041 or the like. Alternatively, the program module 1093 and the program data 1094 related to the comparison program may be stored in another computer connected through a network such as a LAN or a wide area network (WAN), and be read out by the CPU 1020 through the network interface 1070.

Hereinbefore, although the embodiment to which the invention made by the inventor is applied has been described above, the present invention is not limited to the description and drawings constituting a portion of the disclosure of the present invention according to the present embodiment. In other words, all of other embodiments, examples, operational techniques, and the like made by those skilled in the art or the like based on the present embodiment fall within the scope of the present invention.

### REFERENCE SIGNS LIST

1 Communication system
10 Comparison device
13 Communication control unit
14 Storage unit
14a NF configuration
14b Synchronization target information
15 Control unit
15a Acquisition unit
15b Aggregation unit
15c Determination unit
15d Instruction unit
20, 20a, 20b NF
23 Communication control unit
24 Storage unit
24a State information
25 Control unit
25a Synchronization unit
25b Update unit

1. A comparison device comprising:
an acquisition unit, including one or more processors, configured to acquire a packet passing through an active system path and a packet passing through a standby system path;
an aggregation unit, including one or more processors, configured to aggregate pieces of information on the packet using the packet acquired;
a determination unit, including one or more processors, configured to compare the pieces of information on the packet aggregated between the active system path and the standby system path to determine whether there is a difference in state information indicating an operational state in a network function (NF); and
an instruction unit, including one or more processors, configured to instruct an NF of the active system path and an NF of the standby system path facing the NF of the active system path to synchronize the state information in a case where it is determined that there is the difference.

2. The comparison device according to claim 1, wherein the determination unit is configured to compare a number of packets, data of sampled packets, or data of all packets as the pieces of information on the packet aggregated.

3. The comparison device according to claim 1, further comprising
a storage unit configured to store information for managing the state information that is a target for synchronization,
wherein the determination unit is configured to refer to the storage unit to determine whether there is a difference in the state information that is a target for synchronization.

4. A communication system comprising:
a comparison device; and
a network function (NF),
wherein the comparison device includes:
an acquisition unit, including one or more processors, configured to acquire a packet passing through an active system path and a packet passing through a standby system path,
an aggregation unit, including one or more processors, configured to aggregate pieces of information on the packet using the packet acquired,
a determination unit, including one or more processors, configured to compare the pieces of information on the packet aggregated between the active system path and the standby system path to determine whether there is a difference in state information indicating an operational state in an NF, and
an instruction unit, including one or more processors, configured to instruct an NF of the active system path and an NF of the standby system path facing the NF of the active system path to synchronize the state information in a case where it is determined that there is the difference, and
the NF includes:
a synchronization unit, including one or more processors, configured to, in a case where synchronization is instructed from the comparison device, synchronize, with a facing NF, the state information instructed that is a target for synchronization, and
an update unit, including one or more processors, configured to update the state information synchronized.

5. The communication system according to claim 4, wherein the NF has the aggregation unit instead of the comparison device.

6. A comparison method executed by a comparison device, the method comprising:
acquiring a packet passing through an active system path and a packet passing through a standby system path;
aggregating pieces of information on the packet using the packet acquired;
comparing the pieces of information on the packet aggregated between the active system path and the standby system path to determine whether there is a difference in state information indicating an operational state in a network function (NF); and
instructing an NF of the active system path and an NF of the standby system path facing the NF of the active system path to synchronize the state information in a case where it is determined that there is the difference.

7. (canceled)

8. The communication system according to claim 4, wherein the determination unit is configured to compare a number of packets, data of sampled packets, or data of all packets as the pieces of information on the packet aggregated.

9. The communication system according to claim 4, further comprising:
a storage unit configured to store information for managing the state information that is a target for synchronization,
wherein the determination unit is configured to refer to the storage unit to determine whether there is a difference in the state information that is a target for synchronization.

10. The comparison method according to claim 6, further comprising:
comparing a number of packets, data of sampled packets, or data of all packets as the pieces of information on the packet aggregated.

11. The comparison method according to claim 6, further comprising:
storing information for managing the state information that is a target for synchronization; and
referring to the stored information to determine whether there is a difference in the state information that is a target for synchronization.
